(19) United States
(12) Patent Application Publication
(10) Pub. No.: US 2013/0124614 A1
(43) Pub. Date: May 16, 2013

(54) THIN CLIENT SYSTEM AND SERVER APPARATUS

(71) Applicant: Hitachi, Ltd., Tokyo (JP)

(72) Inventors: Takashi Yokoyama, Yokohama-shi (JP); Kozo Ikegami, Yokohama-shi (JP); Koji Nishii, Fujisawa-shi (JP)

(73) Assignee: HITACHI, LTD., Tokyo (JP)

(21) Appl. No.: 13/669,752

(22) Filed: Nov. 6, 2012

(30) Foreign Application Priority Data
Nov. 15, 2011 (JP) 2011-249565

(51) Int. Cl. G06F 15/16

(52) U.S. Cl. 709/203

(57) ABSTRACT

In a thin client system including client terminals and a server apparatus, when a user input operation that requires high-speed reactivity of screen display to the user operation is performed at one of the client terminals, the server can change the amount of data to be transmitted to the client terminal in accordance with the communication quality of the connection network. The client terminal transmits the user input operation in the form of input operation information to the server apparatus, and the server apparatus analyzes the received input operation information, and judges whether the input operation is one that requires high-speed reactivity of screen display to the input operation. If the input operation is one that requires high-speed reactivity of screen display, the server performs the reduction of screen information to be displayed at the client terminal.

### CLAIM OF PRIORITY

The present application claims priority from Japanese patent application serial no. 2011-249565, filed on Nov. 15, 2011, the content of which is hereby incorporated by reference into this application.

### BACKGROUND OF THE INVENTION

The present invention relates to a thin client system and a server apparatus, and more particularly, relates to a thin client system and a server apparatus that perform processing in accordance with the quality of a network.

Recently, in many enterprises and the like, a thin client system, in which client terminals used by employees have only minimum functions and a server connected to the client terminals via a network manages resources such as application software and files, has been attracting increasing attention.

In a thin client system, a server apparatus performs various processing including applications and the like on the basis of operation information transmitted from client terminals, and screen information to which the processing results are reflected is transmitted to the client terminals.

Early thin client systems have usually been operated in networks with their communication qualities of certain guaranteed levels such as local area networks (LANs) within the premises of enterprises (referred to as LANs for short hereinafter), but recently networks that are connected to wide area networks (WANs), wireless LANs, and mobile networks, that is, networks with various communication qualities have been widely spread, hence a server and a client have come to be connected via these networks with various communication qualities.

In the case where thin client terminals are connected to a server apparatus via a network with a slow communication speed such as a mobile network, there occurs a problem in that a delay is introduced in the transmission of screen information data, hence it takes a time for the screen to be displayed. Therefore, new techniques has been proposed as well as typical image compression techniques such as a technique in which an image is compressed and transmitted, or only difference information obtained by comparing an image to be transmitted with a previously transmitted image is transmitted. For example, in view of screen display characteristics that are unique to the thin client system and are observed at the time of window operations by a user, Japanese Unexamined Patent Application Publication No. 2008-225516 proposes a technique in which a window displacement performed by the user is detected with the use of movement information about a pointer cursor, and image information to be transmitted to a client terminal can be reduced at the time of a window displacement operation performed by the mouse dragging operation.

As input devices used for terminals, in addition to conventional keyboards and mice, mice with a wheel, multi-touch touch panels, track pads, and the like have been widely used, hence there have come into existence many user operations that require high-speed reactivity of screen display to the user operations such as scrolling with the use of a mouse wheel, pinch-in (shrinking) and pinch-out (expanding) with the use of a touch panel.

### SUMMARY OF THE INVENTION

Since there are various networks with different communication qualities used for thin client systems, in the case where a thin client system is configured with the use of a network, there is a problem in that constant operationality and a constant reaction speed of screen display have to be secured by changing the amount of data transmitted between client terminals and a server apparatus and by changing a transmission method for transmitting the data in accordance with the communication quality of the network.

In addition, in the case where a network whose communication quality is rapidly changed owing to the movements of terminals or the variations of radio wave conditions such as a mobile network is used in a thin client system, there is a problem in that constant operationality and a constant reaction speed of screen display have to be secured by changing the amount of data transmitted and a transmission method for transmitting the data between a client terminal and a server apparatus in consideration of the ever-changing communication quality of the network between the client terminal and the server apparatus.

In addition, in a thin client system, information generated by a user operation at a client terminal is transmitted to a server apparatus via a network, and resultant data generated in the processing at the server apparatus is transmitted to the client terminal and the resultant data is displayed at the client terminal. Therefore, there arises a time-lag between the time of the user operation and the time when the resultant data is displayed at the client terminal.

Since a character input with a character key of a keyboard or a cursor displacement with a cursor key does not bring about a large change in a display content in response to the operation, the amount of data transmitted between a client terminal and a server apparatus is small. Therefore, if the communication quality of the network is inferior and a sufficient bandwidth cannot be secured, a large time-lag does not arise even. On the other hand, an operation such as scrolling with a mouse wheel, pinch-in (shrinking) or pinch-out (expanding) with a touch panel brings about a large change in display content in response to the operation, and the amount of data transmitted between the client terminal and the server apparatus is large. Therefore, a large time-lag arises if the communication quality of the network is inferior and a sufficient bandwidth cannot be secured. In this case, the speed of a wheel operation, the amount of rotation of a wheel, the speed or width of a pinch-in/pinch-out operation of a touch panel works as information about the changing rate or the amount of a change in a display content indicated by a user. In the above case, there is a possibility that, if a reaction of screen display in response to the user operation has a large delay, the user repeats an unnecessary similar operation, which leads to an inferior operational feeling.

On the other hand, in the case where the user performs a scrolling operation, a pinch-in operation, or a pinch-out operation, it is required that a reaction to the user operation can be linearly recognized on the screen, and it is not required that, while a display content is changing, the display content is superior as long as the amount of the change in the display content can be grasped eventually.

In addition, in a thin client system, there are two types of user operations-one type is an operation that requires a high quality of screen display although it takes a quantity of time to start the display such as e-mail reading, document composition, and moving image reproducing, and the other type is an operation that requires high-speed reactivity of screen display to the user's operation. Therefore, there is a problem in that it is necessary to judge which type a user operation is an operation that requires a high quality of screen display or an operation that requires high-speed reactivity of screen display.

Japanese Unexamined Patent Application Publication No. 2008-225516 discloses a method in which the improvement of a high-speed reactivity of screen display to a user operation can be expected only when the user performs a specific operation in which a displacement in a window is performed only with the use of a mouse. Therefore, the method disclosed in this patent application publication cannot be applied to an operation in which a display content is changed such as a scrolling operation of a display content in a window with the use of a mouse wheel, a pinch-in (shrinking) operation or a pinch-out (expanding) operation with the use of a touch panel.

The above-described problems can be solved by a thin client system configured in the following way. In this thin client system in which client terminals and a server apparatus are connected via a network, when one of the client terminals transmits input operation information to the server apparatus via the network, the server apparatus performs application processing on the basis of the received operation information, generates image information on the basis of the processing result, and transmits the image information to the client terminal via the network. Next, the client terminal displays the received image information. In this thin client system, each client terminal and the server apparatus are respectively equipped with communication quality check processing units for measuring the communication quality of the network, and the server apparatus determines an amount of data of the image information to be transmitted to the client terminal on the basis of the communication quality.

In addition, as an alternative thin client system that can solve the above-described problems, there is a thin client system configured in the following way. The thin client system includes client terminals, a server apparatus, and the client terminals and the server apparatus are connected via a network, in which the server apparatus that receives operation information from one of the client terminals performs application processing, generates image information on the basis of the processing result, and transmits the image information to the client terminal via the network. In addition, the server is equipped with a communication quality check processing unit for measuring the communication quality of the network, and the server apparatus determines the amount of data of the image information to be transmitted to the client terminal on the basis of the communication quality.

In the thin client system according to an aspect of the present invention, the improvement of a processing response to a user operation that requires a high-speed reactivity to the user operation can be achieved. In addition, even in the case where the client terminals and the server apparatus are connected via plural networks with different communication qualities or via a network with a dynamically changing communication quality, a flexible screen display that copes with the communication quality of the entirety of the thin client system can be obtained.

### BRIEF DESCRIPTION OF THE DRAWINGS

FIG. 1 is a block diagram for explaining the configuration of a thin client system;

FIG. 2 is a block diagram for explaining communication contents exchanged between a server apparatus and a client terminal;

FIG. 3 is a block diagram of the client terminal;

FIG. 4 is a block diagram of the server apparatus;

FIG. 5 is a diagram for explaining input operation information;

FIG. 6 is a flowchart of input operation processing at the client terminal;

FIG. 7 is a flowchart of screen display processing at the client terminal;

FIG. 8 is a flowchart of processing performed at the server apparatus;

FIG. 9 is a sequence chart of a communication quality check;

FIG. 10 is a diagram for explaining input operation information;

FIG. 11 is a diagram for explaining the changes of a screen display;

FIG. 12 is a block diagram for explaining the processing of a screen information generation processing unit;

FIG. 13 is a diagram for explaining screen information after reduction processing (No. 1);

FIG. 14 is a diagram for explaining screen information after reduction processing (No. 2);

FIG. 15 is a diagram for explaining a delay between the server apparatus and the client terminal (No. 1);

FIG. 16 is a diagram for explaining a delay between the server apparatus and the client terminal (No. 2); and

FIG. 17 is a diagram for explaining a delay between the server apparatus and the client terminal (No. 3).

### DESCRIPTION OF THE EMBODIMENT

Hereinafter, an embodiment of the present invention will be described with the use of examples and with reference to the accompanying drawings. In addition, components substantially identical to each other are given the same reference numerals, and redundant descriptions regarding the components will be omitted for avoiding overlap.

A thin client system will be described with reference to FIG. 1. In FIG. 1, the thin client system 4 includes client terminals 1, and a server apparatus 3. The client terminals are connected to the server apparatus via a network 2. FIG. 1 shows that three client terminals 1-1, 1-2, and 1-3 are connected to the server apparatus 3. Three client terminals shown in FIG. 1 are for illustration only, and it goes without saying that the number of the client terminals is not restricted to three, and arbitrary number of the client terminals can be connected to the server apparatus. In addition, the network 2 is not restricted to one type of network among a wired network, a wireless network, a LAN, or a WAN. It is conceivable that the network 2 is composed of plural networks of different connection types or the network 2 is a network composed plural networks connected in series.

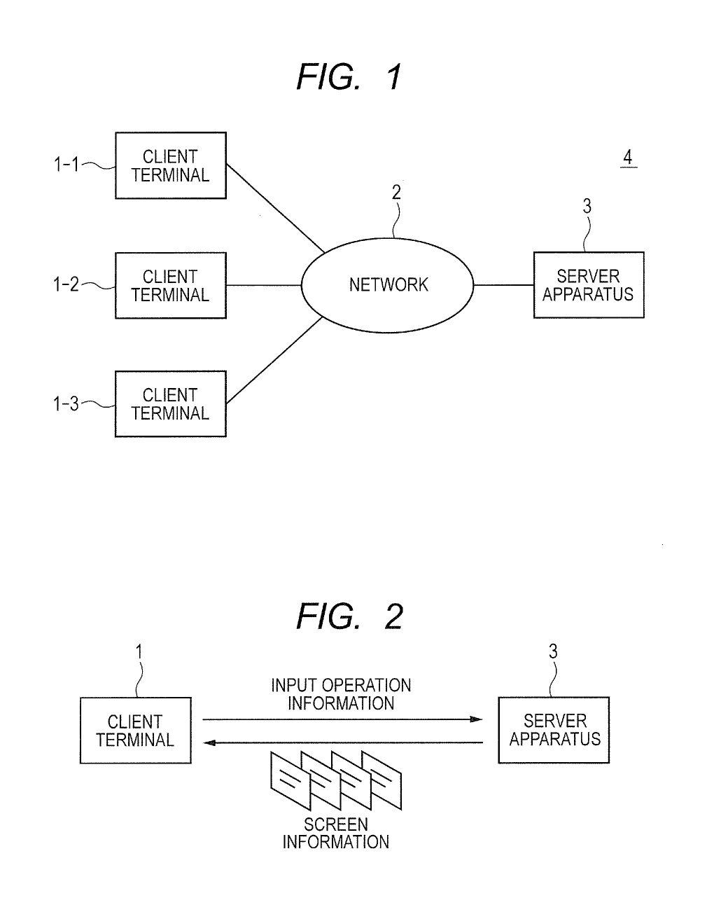

Communication contents exchanged between the server apparatus and one of the client terminals will be described with reference to FIG. 2. In FIG. 2, input operation information that is input to the client terminal 1 is transmitted to the server apparatus 3. The server apparatus performs application processing on the basis of the received input operation information. The server apparatus 3 transmits the processing result to the client terminal 1 as screen information. The client terminal 1 performs screen display on the basis of the screen information.

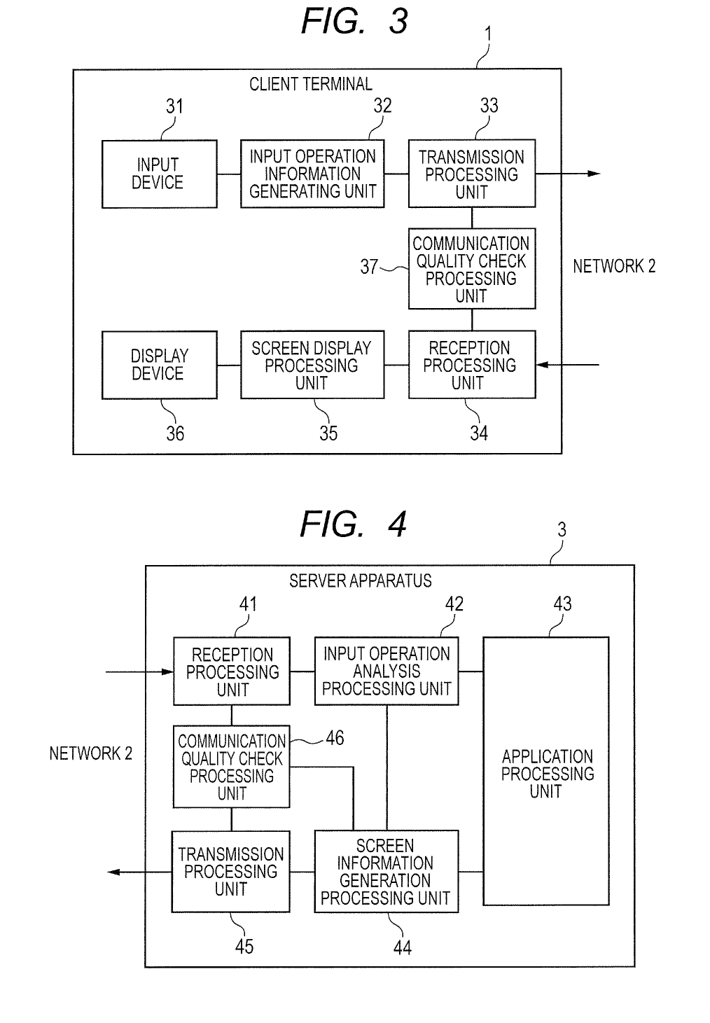

The configuration of the client terminal will be described with reference to FIG. 3. FIG. 3 shows that the client terminal 1 includes some function blocks; that is, an input device 31; an input operation information generating unit 32; a transmission processing unit 33; a reception processing unit 34; a screen display processing unit 35; a display device 36; and a communication quality check processing unit 37.

The input device 31 includes a key board; a pointing device such as a mouse or a track pad; and a touch panel. The input device 31 outputs an operation content, which is provided by a key input or a pointing device operation performed by a user, to an input operation information generating unit 32.

The input operation information generating unit 32 analyzes the operation content, and generates input operation information to be transmitted to the server apparatus 3. Next, the input operation information generating unit 32 outputs the input operation information to the transmission processing unit 33.

The transmission processing unit 33 transmits the input operation information input from the input operation information generating unit 32 to the server apparatus 3 via the network 2. The reception processing unit 34 receives the screen information from the server apparatus 3 via the network 2. The reception processing unit 34 outputs the screen information to the screen display processing unit 35.

The screen display processing unit 35 generates screen display to be displayed on the display device 36 from the input screen information. The screen display processing unit 35 outputs the screen display to the display device 36. The display device 36 is, for example, a liquid crystal display. The display device 36 displays the screen display input from the screen display processing unit 35. The communication quality check processing unit 37 performs check processing for checking the communication quality of the network 2 via which the client terminal 1 and the server apparatus 3 are connected to each other.

The client terminal 1 is a terminal device that includes the above-described function blocks. The input device 31 and the display device 36 included in the client terminal 1 are not restricted to specific types of input device and display device respectively. It is conceivable that the client terminal 1 is not only a notebook PC or a desktop PC but also a smart phone, a tablet terminal equipped with a touch panel or the like.

The server apparatus will be described with reference to FIG. 4. FIG. 4 shows that the server apparatus 3 includes some function blocks; that is, a reception processing unit 41; an input operation analysis processing unit 42; an application processing unit 43; a screen information generation processing unit 44; a transmission processing unit 45; and a communication quality check processing unit 46.

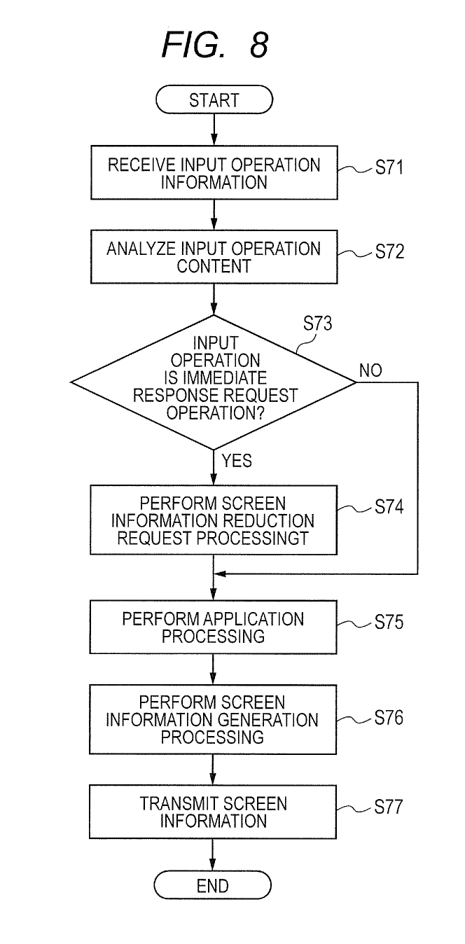

The reception processing unit 41 receives the input operation information transmitted from the client terminal 1 via the network 2. The reception processing unit 41 outputs the input operation information to the input operation analysis processing unit 42. The input operation analysis processing unit 42 analyzes the operation content using the input operation information input from the reception processing unit 41, and outputs the obtained result to the application processing unit 43. The input operation analysis processing unit 42 also judges whether the user performs an operation that requires an immediate response of the screen display to the operation. The input operation analysis processing unit 42 issues a screen information reduction request to the screen information generation processing unit 44. The details of the above behavior of the server apparatus 3 will be described later with reference to FIG. 8.

The application processing unit 43 performs application processing in accordance with the input operation content. The application processing unit 43 outputs a processing result to the screen information generation processing unit 44. The screen information generation processing unit 44 performs screen information generation processing to be transmitted to the client terminal 1 with the use of the processing result input from the application processing unit 43. The screen information generation processing unit 44 outputs the screen information to the transmission processing unit 45. The transmission processing unit 45 transmits the input screen information to the client terminal 1 via the network 2. The communication quality check processing unit 46 performs check processing for checking the communication quality of the network 2 via which the client terminal 1 and the server apparatus 3 are connected to each other.

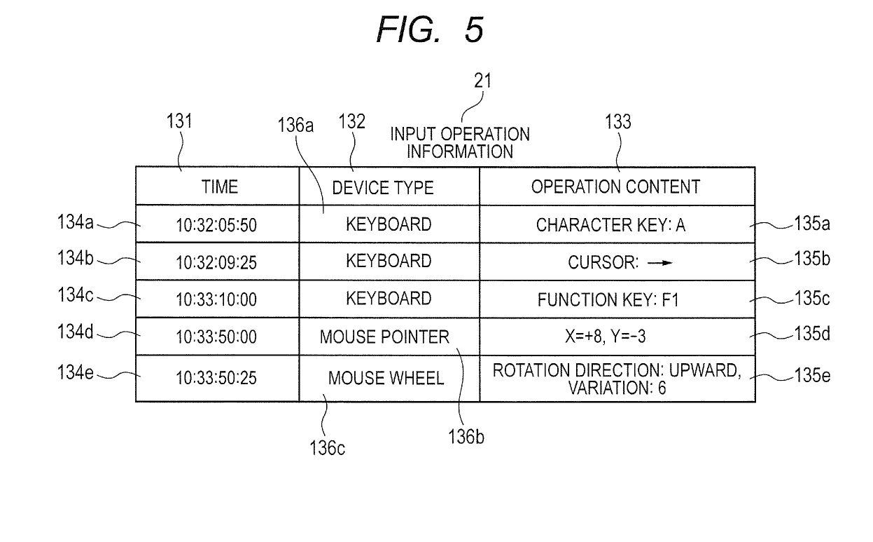

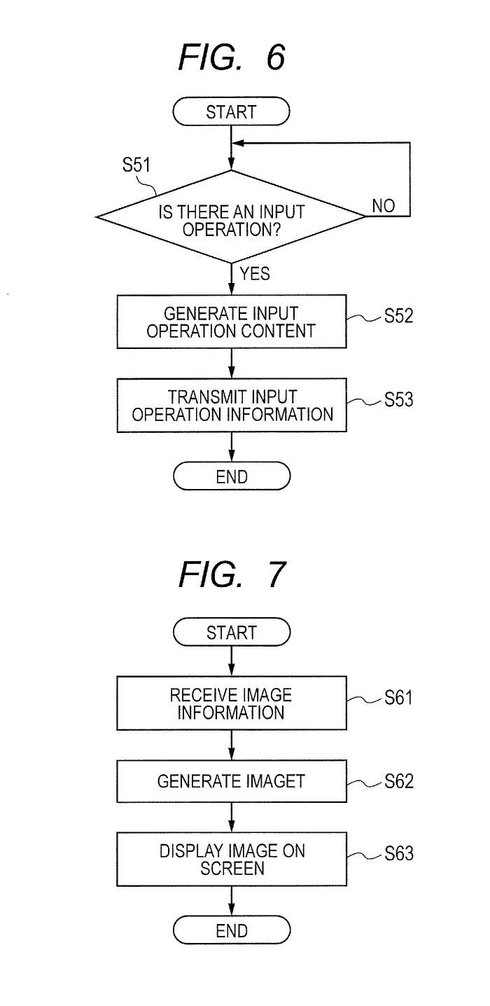

Next, the behavior of the client terminal 1 will be described. First, the input operation processing of the client terminal 1 will be described with reference to FIGS. 5 and 6.

The input operation information will be described with reference to FIG. 5. FIG. 5 shows that the input operation information includes time 131, device type 132, and operation content 133.

Five times 134a to 134e are registered as time 131. “10:32:05:50” in the row 134a shows “10 o'clock 32 minutes 5.50 seconds”. Here, the times that are obtained by sampling the time information of the client terminal every 250 milliseconds are registered as time 131. However, the resolution of the above sampling interval is not restricted to 250 milliseconds as long as input operations by a user can be distinguished one-by-one. Alternatively, information about the counter values of a timer counter that increase and decrease at a constant frequency can be used as time information.

The device types are a key board 136a, a mouse pointer 136b, a mouse wheel 136c. In the input operation information, the operation contents 133 are defined for device types individually. In the case where the device type 132 is a keyboard 136a as shown in the row 134a, the key information input from the keyboard 136a such as “Character Key: A” (135a), “Cursor: ” (135b), and “Function Key: F1” (135c) are registered as the operation content 133. In the case where the device type 132 is a mouse pointer (136b) and the X-axis component of the distance of the mouse is +8 and the Y-axis component is −3, “X=+8, Y=−3” (135d) is registered as the operation content 133. In the case where the device type 132 is a mouse wheel (in the row 134e), the operation information such as “Rotation Direction: Upward, Variation: 6” (135e) that indicates the rotation of the wheel mounted in the mouse is registered as the operation content 133.

Here, the registration formats of time 131, device type 132, and operation content 133 are not restricted to those shown by the input operation information in FIG. 5. In addition, information about items other than time 131, device type 132, and operation content 133 can be used as part of the input operation information.

The input operation processing of the client terminal 1 will be described with reference to FIG. 6. In FIG. 6, the client terminal 1 judges whether there is an input operation from the input device 31 (at S51). If there is no input operation (NO at S51), the flow in the client terminal 1 goes back to step 51 again. If there is an input operation (YES at S51), the client terminal 1 generates the operation content of the input device 31 (at S52). The client terminal 1 transmits the generated input operation information, and the flow ends (at S53).

To put it concretely, the input operation information generating unit 32 analyzes device type 132 and operation content 133. The input operation information generating unit 32 generates key input information, pointing device position information, information about the changing direction and variation of the mouse wheel as well as the time input from the input device as input operation information, and outputs this input operation information to the transmission processing unit 33 (at S52). The transmission processing unit 33 transmits the input operation information input from the input operation information generating unit 32 to the server apparatus 3 via the network 3 (at S53).

Next, the screen display processing at the client terminal 1 will be described with reference to FIG. 7. As shown in FIG. 7, the client terminal 1 receives the image information (at S61). The client terminal 1 generates an image (at S62). The client terminal 1 displays the image (at S63), and the flow ends.

To put it concretely, the reception processing unit 34 receives the screen information from the server apparatus 3 via the network 2, and outputs the screen information to the screen display processing unit 35 (at S61). The screen display processing unit 35 performs decoding of the received screen information and the like, generates screen display information to be displayed on the display device 36, and outputs the screen display information to the display device 36 (at S62). The display device 36 displays the screen display information input from the screen display processing unit 35 (at S36).

The processing at the server apparatus 3 will be described with reference to FIG. 8. As shown in FIG. 8, the server apparatus 3 receives the input operation information (at S71). The server apparatus 3 analyzes the input operation content (at S72). The server apparatus 3 judges whether the input operation is an immediate response request operation (at S73). If the input operation is the immediate response requesting operation (YES at S73), the server apparatus 3 performs screen information reduction request processing (at S74). If the input operation is not the immediate response requesting operation (NO at S73), or after the step 74, the server apparatus 3 performs the application processing (at S75). The server apparatus 3 performs the screen information generating processing (at S76). The server apparatus 3 transmits the screen information (at S77), and the flow ends.

To put it concretely, the reception processing unit 41 receives the input operation information from client terminal 1 via the network 2, and outputs the input operation information to the input operation analysis processing unit 42 (at S71). The input operation analysis processing unit 42 analyzes the input operation information, and converts the input operation information into data in a data format that can be used by the application processing unit 43, and outputs the converted data to the application processing unit 43 (at S72). At the step 72, it is also judged whether a Shift key, a Ctrl key, or an Alt key, which has a function to be operated at the same time as other character keys, is pushed at the same time as any of the other character keys, or whether a mouse is moved with its click button kept pushed (in other words, whether the mouse is dragged).

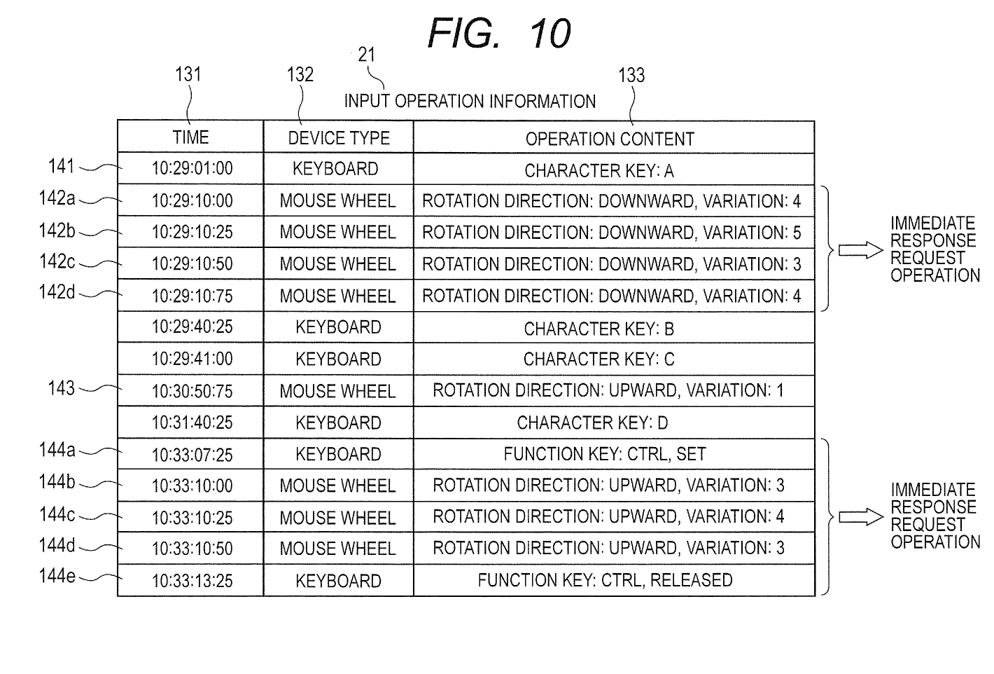

In addition, the input operation analysis processing unit 42 analyzes the input operation information, and judges whether the operation content indicates an operation that requests an immediate response. The detail of this judgment will be explained later with reference to the input operation information shown in FIG. 10. In addition, although this detail of the judgment will be explained taking the rotation of a mouse wheel for illustration, it is conceivable that a dragging operation with a mouse, a pinch-in (shrinking) or a pinch-out (expanding) operation with the use of a touch panel is taken for illustration.

If it is judged that the operation requests an immediate response (in the case of YES at S73), the input operation analysis processing unit 42 issues the screen information reduction request to the screen information generation processing unit 44 (at S74). If it is judged that the operation does not request an immediate response (in the case of NO at S73), the flow goes to the application processing (at S75).

The application processing unit 43 performs the application processing on the basis of the information input from the input operation analysis unit 42, and outputs the processing result to the screen information generation processing unit 44 (at S75). The screen information generation processing unit 44 generates screen information to be displayed at the client terminal 1 and encodes an image on the basis of the processing result sent from the application processing unit 43, and outputs the screen information and the encoded image data to the transmission processing unit 45 (at S76). The transmission processing unit 45 transmits the screen information input from the screen information generation processing unit 44 to the client terminal 1 via the network 2 (at S77).

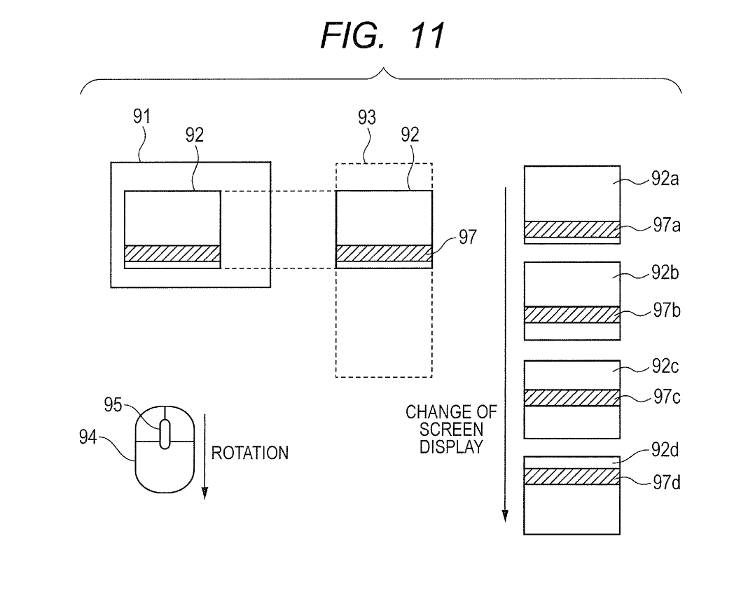

In addition, in the case where it is judged that the input operation information from the client terminal 1 requests an immediate response of screen display to the input operation in the input operation analysis processing unit 42, and the screen information reduction request is issued to the screen information generation processing unit 44, the behavior of the screen information generation processing unit 44 will be described later with reference to FIG. 11 to FIG. 14.

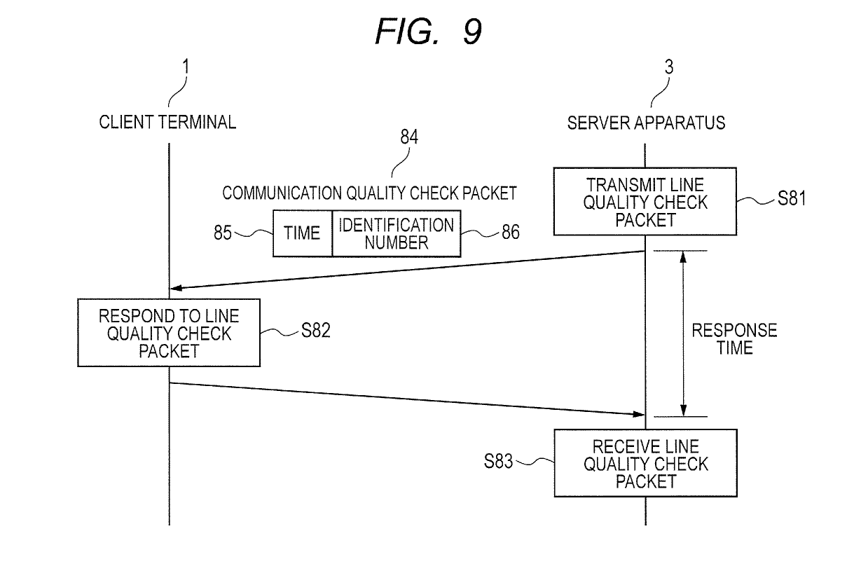

Communication quality check processing performed on the network 2 that connects the client terminal 1 and the server apparatus 3 will be described with reference to FIG. 9. In FIG. 9, the communication quality check processing unit 46 of the server apparatus 3 creates a communication quality check packet 84, and transmits the communication quality check packet 84 to the client terminal 1 via the transmission processing unit 45 (at S81). The communication quality check packet 84 includes the field for time 85 and the field for identification number 86, and time information about the time when the packet is created is set in the field for time 85, and a number for identifying each packet is set in the field for identification number 86.

Next, on receiving the communication quality check packet 84 via the reception processing unit 34, the communication quality check processing unit 37 of the client terminal 1 immediately sends back the communication quality check packet 84 to the server apparatus 3 without changing the values of both fields (at S82).

The communication quality check processing unit 46 of the server apparatus 3 receives the communication quality check packet 84 sent back from the client terminal 1 via the reception processing unit 41 (at S83), and calculates a response time by comparing the time set in the field of time 85 with the time when the communication quality check processing unit 46 receives the communication quality check packet 84. A response time is short if the communication quality of a network is good, and a response time is long if the communication quality of a network is bad. Therefore, the communication quality of a network can be estimated by knowing whether the response time of the network is short or long.

In addition, the communication quality check processing unit 46 of the server apparatus 3 performs this communication quality check at predetermined intervals. The communication quality check processing unit 46 of the server apparatus 3 outputs communication quality information obtained through the communication quality check processing to the screen information generation processing unit 44.

In this case, it is conceivable that the estimation of the communication quality of the network 2 is performed not only using a response time of one communication quality check packet 84 but also using an average response time of response times of plural communication quality check packets 84, which may prevent the evaluation accuracy of the communication quality of the network 2 from being deteriorated owing to temporary fluctuations of the communication quality of the network 2. In addition, by examining the contents of the fields of identification number 86 of plural communication quality check packets, the number of communication quality check packets that are lost on the network 2 and hence not sent back to the server apparatus 3 can be counted. Therefore it is conceivable that the packet loss rate measured as above or the like is made to be one of the indices showing the communication quality estimation information.

Although, as described above, the communication quality check has been performed with the use of the communication quality check packet 84, typically used methods such as a method using a response time of a ping, and a round trip time (RTT) of transmission control protocol (TCP) can be used for the check of the communication quality.

The detail of the judgment performed in the input operation analysis processing unit 42 for judging whether an operation content indicates that the input operation is an operation that requests an immediate response will be described with reference to FIG. 10. In FIG. 10, the input operation information 141, which has “10:29:01:00” as time 131, has “keyboard” as device type 132, and “character key: A” as operation content 133, hence the input operation information 141 indicates that the character key “A” of the keyboard is pushed at the time 10 o'clock 29 minutes 01.00 seconds. Since input operations such as a character input using a keyboard do not bring about a large change in the screen display in response to the input operations, and the amount of data transmitted to the client terminal is small, there arises no delay in the screen display at the client terminal. In addition, since a user checks whether the character he/she inputs with the keyboard is correct on the screen of the client terminal, it is judged that the input operation is an operation that requires a high quality of the screen display, and not an operation that requires a high-speed reactivity of the screen display to an input operation. Therefore, while input operations using a keyboard are being performed, the input operation analysis processing unit 42 does not issue the screen information reduction request to the screen information generation processing unit 44.

Next, plural pieces of input operation information 141a to 141d, which have “10:29:10:00” to “10:29:10:75” as time 131, show that device type 132 is “mouse wheel”, and that the mouse wheel is continuously rotated at high speeds. Such an input operation as this, in which a mouse wheel is continuously rotated and the variation of the mouse wheel is large, often occurs when the user scrolls a displayed window. In this case, a change in the screen display is very large, and the amount of data about the screen information to be transmitted to the client terminal is very large. As a result, if the communication quality of the network is bad, there arises a large delay in the screen display at the client terminal. In addition, it is in the case where the user wants to display information that is not displayed in the current window that the user scrolls the displayed window with a mouse wheel. In other words, the user will be satisfied if he/she can grasp the longitudinal length of the displayed window scrolled by the user with the mouse wheel, and it is not always required that the quality of the screen display is superior while the screen display is changing as long as the reactions to the user operations can be linearly recognized on the displayed screen even if the quality of the screen display that is currently changing is bad to a certain degree. To put it simply, it is judged that the above input operation is not an operation that requires a high quality of the screen display, but an immediate response requesting operation that requests a high-speed reactivity to an input operation. As a result, while this operation is being performed, the input operation analysis processing unit 42 issues a screen information reduction request to the screen information generation processing unit 44.

Next, input operation information 143, which have “10:30:50:75” as time 131, shows that device type 132 is “mouse wheel”, and that the mouse wheel is rotated in a similar way to the plural pieces of input operation information 142a to 142d. In this case, however, the input operation of the mouse wheel is not performed continuously, and the variation of the mouse wheel is small, that is, “1”. Therefore, a change in the screen display in response to this input operation is small, and the amount of data about the screen information to be transmitted to the client terminal is small, hence there arises no delay in the screen display at the client terminal. In this case, since it is required that the content of the screen display can be correctly judged, it is judged that the above input operation is not an operation that requires a high-speed reactivity to an input operation, but an operation that requires a high quality of the screen display. In other words, while this operation is being performed, the input operation analysis processing unit 42 does not issue the screen information reduction request to the screen information generation processing unit 44.

Next, the judgment about plural pieces of input operation information 144a to 144d, which have “10:33:07:25” to “10:33:13:25” as time 131, will be described. The input operation information 144a, which has “10:33:07:25” as time 131, shows that device type 132 is “keyboard”, and that operation content is “function key: Ctrl, set”, which means that a Ctrl key, which has a function to be operated at the same time as another operation is made, is in the state of being pushed. Plural pieces of input operation information 144b to 144d, which have “10:33:10:00” to “10:33:10:50” as time 131, show that device type 132 is “mouse wheel”, and that the mouse wheel is continuously rotated at high speeds. Input operation information 144e, which has “10:33:13:25” as time 131, shows that device type 132 is “keyboard”, and that operation content is “function key: Ctrl, released”, which means that a Ctrl key that is pushed at the input operation 144a is released.

A series of input operations shown by 144a to 144e are operations in which the user continuously rotates the mouse wheel while pushing Ctrl key, which has a function to be operated at the same time as other keys are operated, is being pushed. These operations often occur when the user tries to shrink or expand a displayed window. In these operations, changes in the screen display in response to these input operations are large, and the amount of data about the screen information to be transmitted to the client terminal is large. Therefore, if the communication quality of the network is bad, there arises a large delay in the screen display at the client terminal. In addition, in this case, the user will be satisfied if he/she can grasp the variation of the expansion or shrinkage of the screen display performed in accordance with the rotation of the mouse wheel. In other words, even if the quality of the screen display that is currently changing is bad to a certain degree, it is all right with the user as long as the reactions to the user operations can be linearly recognized on the displayed screen. Therefore, it is judged that the above input operations are not operations that require a high quality of the screen display, but immediate response requesting operations that requests a high-speed reactivity to an input operation. In other words, while these operations are being performed, the input operation analysis processing unit 42 issues the screen information reduction request 153 to the screen information generation processing unit 44.

In the above description, although the operation about the rotation of the mouse wheel has been taken for an example, operations such as a dragging operation with a mouse, a pinch-in (shrinking) operation and a pinch-out (expanding) operation with a touch panel can be taken as an immediate response requiring operations.

Next, the behavior of the screen information generation processing unit 44 that performs the screen information reduction processing in accordance with the communication quality of the network will be described with reference to FIG. 11 to FIG. 14.

First, the changes of a screen display will be described with reference to FIG. 11.

In FIG. 11, a screen 91 is a screen displayed on the display device 36 of the client terminal 1. A window 92 is displayed on the screen 91. In this case, it will be assumed that the entirety of information 93 cannot be displayed in the window 92, therefore only some of the information is displayed on the window 92. In this situation, when a mouse wheel 95 mounted on a mouse 94, which is the input device 31 of the client terminal 1, is rotated in the near side direction, the display of the window 92 changes from a window 92a to a window 92b, a window 92c, and a window 92d. The display area 97 in the window 92 moves upward from the display area 97a to the display area 97b, the display area 97c, and the display area 97d in accordance with the rotation of the mouse wheel 95. Here, although only the display area 97 has been taken for an example in order to explicitly explain the movement of the window 92, both display areas over and under the display area 97 also move in the same way as the display area 97 moves.

A user who operates the client terminal 1 often continuously rotates the mouse wheel 95 when he/she wants to quickly view a display area that is currently not displayed as shown in FIG. 11. Therefore, if there arises a quantity of time-lag between the time when the user rotates the mouse wheel 95 and the time when the screen display changes in accordance with the user's input operation, high-speed reactivity of screen display to the user's operation is lost, which gives an inferior operational feeling to the user.

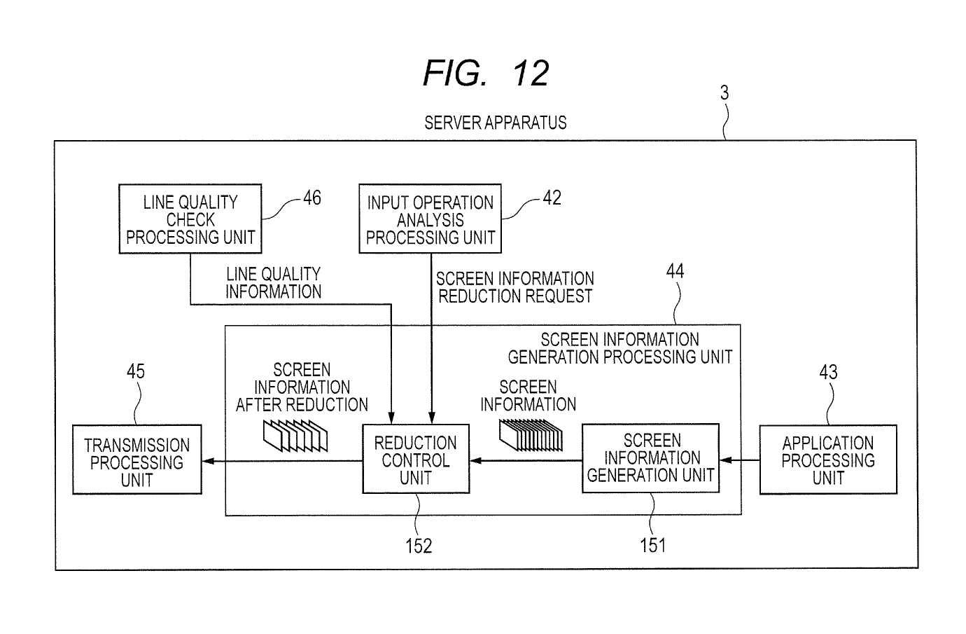

The behavior of the screen information generation processing unit 44 will be described with reference to FIG. 12. As shown in FIG. 12, the screen information generation processing unit 44 of the server apparatus 3 includes a screen information generation unit 151 and a reduction control unit 152.

The screen information generation unit 151 generates screen information to be displayed at the client terminal 1 on the basis of the processing result input from the application processing unit 43. The screen information generation unit 151 outputs the screen information to the reduction control unit 152. The reduction control unit 152 receives a screen information reduction request from the input operation analysis processing unit 42, and communication quality information from the communication quality check processing unit 46. The reduction control unit 152 performs reduction control over screen information 155 input from the application processing unit 43 on the basis of these pieces of information. The reduction control unit 152 outputs screen information after reduction processing to the transmission processing unit 45. In the case where the reduction is not performed, the reduction control unit 152 outputs the screen information received from the screen information generation unit 151 as it is to the transmission processing unit 45.

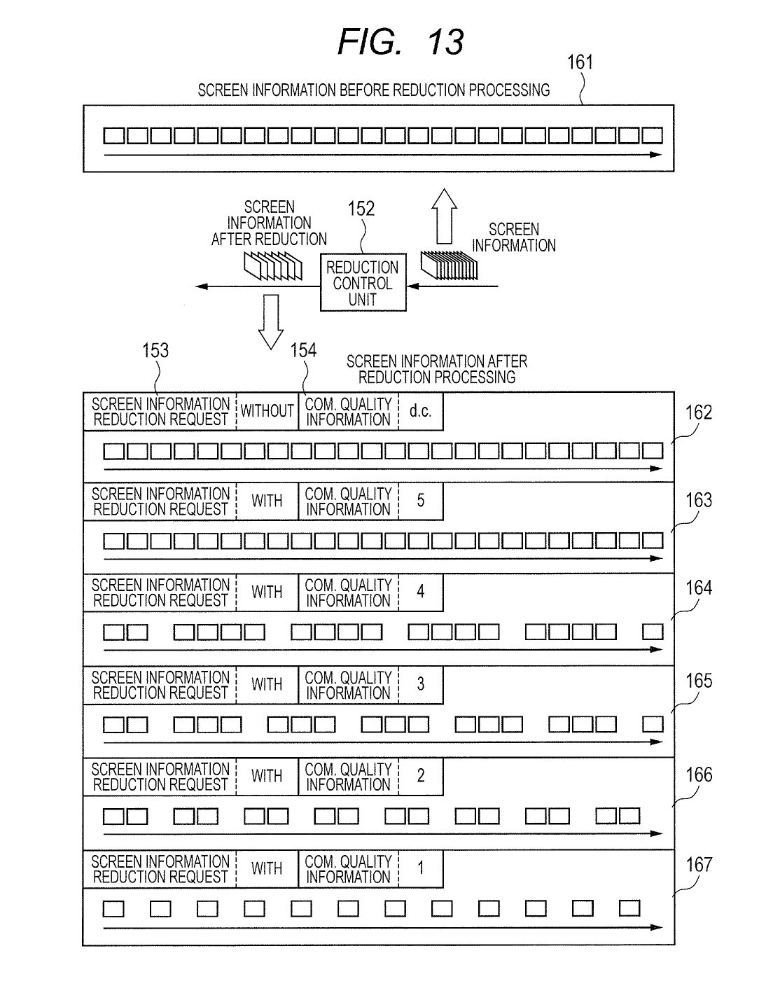

A method, in which the reduction control unit 152 determines the amount of the screen information to be reduced on the basis of the screen information reduction request 153 and the communication quality information 154, will be described with reference to FIG. 13. FIG. 13 shows that screen information 161 before reduction processing has a series of screen information elements arranged along with the passage of time from left to right. In addition, each of pieces of screen information 162 to 167 after reduction processing also has a series of screen information elements on which reduction control is performed by the reduction control unit 152 and which are arranged along with the passage of time from left to right in the same way as the screen information 161 before reduction processing.

The behavior of the reduction control unit 152 in the case where an operation that does not require a high-speed reactivity to an input operation is performed will be described with reference to the screen information 162 after reduction processing. The input operation analysis processing unit 42 does not issue the screen information reduction request 153 to the reduction control unit 152 while an operation that does not require a high-speed reactivity to an input operation such as a character input operation with a keyboard is being performed. Therefore, the reduction control unit 152 outputs the screen information 161 before reduction processing that is not reduced as the screen information 162 after reduction processing regardless of the communication quality information 154 from the communication quality check processing unit 46. Here, “d.c.” in FIG. 13 is “don't care”.

Next, the behavior of the reduction control unit 152 in the case where an operation that requires a high-speed reactivity to an input operation is performed will be described with reference to plural pieces of the screen information 163 to 167 after reduction processing.

The input operation analysis processing unit 42 issues the screen information reduction request 153 to the reduction control unit 152 while an operation that requires a high-speed reactivity to an input operation such as a scrolling operation with a mouse wheel is being performed. The reduction control unit 152 reduces the amount of data of the screen information 161 before reduction processing so that the resultant amount of data of the screen information can be transmitted without a quantity of delay in the network whose the communication quality is estimated on the basis of the communication quality information 154 from the communication quality check processing unit 46. Afterward, the plural pieces of screen information 163 to 167 after reduction processing obtained in accordance with individual communication qualities are output. Here, the amount of data of the screen information 163 after reduction processing is not reduced as is the case with the screen information 161 before reduction processing.

The communication qualities of the network between the client terminal 1 and the server apparatus 3 that are measured at the communication quality check processing unit 46 are classified into five ranks. The ranks are “5”, “4”, “3”, “2”, and “1” in the order of the communication quality from highest to lowest, and each rank is set as the communication quality information 154 for corresponding screen information after reduction processing. In the above description, the communication qualities are classified into five ranks, but the number of the ranks is not restricted to five, and the number of the ranks can be less or more.

In the case where the communication quality information 154 is “5”, since the communication quality is the best, the screen information 161 before reduction processing is output as the screen information 163 after reduction processing after it is not reduced or reduced at a minimum. FIG. 13 shows the screen information 163 after reduction processing as an example that is not reduced at all. In the case where the communication quality information 154 is “4”, since the communication quality is the second-best next to “5”, the screen information 161 before reduction processing is reduced more than in the case where the communication quality information 154 is “5”, and the resultant screen information is output as the screen information 164 after reduction processing. FIG. 13 shows that the screen information 164 after reduction processing is obtained through reducing the screen information 161 before reduction processing by thinning out one screen information element out of five screen information elements. Although one screen information element is thinned out from five screen information elements in this case, it is conceivable that, in order for the amount of data of the screen information 164 after reduction processing to be less than a predetermined amount of data, the rate of thinning-out the screen information elements is adjusted in accordance with the amount of data of the screen information 161 before reduction processing.

In the case where the communication quality information 154 is “3”, since the communication quality is the third-best next to “4”, the screen information 161 before reduction processing is reduced more than in the case where the communication quality information 154 is “4”, and the resultant screen information is output as the screen information 165 after reduction processing. FIG. 13 shows that the screen information 165 after reduction processing is obtained through reducing the screen information 161 before reduction processing by thinning out one screen information element out of four screen information elements. Although one screen information element is thinned out from four screen information elements in this case, it is conceivable that, in order for the amount of data of the screen information 165 after reduction processing to be less than a predetermined amount of data, the rate of thinning-out the screen information elements is adjusted in accordance with the amount of data of the screen information 161 before reduction processing.

In the case where the communication quality information 154 is “2”, since the communication quality is the fourth-best next to “3”, the screen information 161 before reduction processing is reduced more than in the case where the communication quality information 154 is “3”, and the resultant screen information is output as the screen information 166 after reduction processing. FIG. 13 shows that the screen information 166 after reduction processing is obtained by thinning out one screen information element out of three screen information elements. Although one screen information element is thinned out from three screen information elements in this case, it is conceivable that, in order for the amount of data of the screen information 166 after reduction processing to be less than a predetermined amount of data, the rate of thinning-out the screen information elements is adjusted in accordance with the amount of data of the screen information 161 before reduction processing.

In the case where the communication quality information 154 is “1”, since the communication quality is the worst, the screen information 161 before reduction processing is reduced more than in the case where the communication quality information 154 is “2”, and the resultant screen information is output as the screen information 167 after reduction processing. FIG. 13 shows that the screen information 166 after reduction processing is obtained by thinning out one screen information element out of two screen information elements. Although one screen information element is thinned out from two screen information elements in this case, it is conceivable that, in order for the amount of data of the screen information 167 after reduction processing to be less than a predetermined amount of data, the rate of thinning-out the screen information elements is adjusted in accordance with the amount of data of the screen information 161 before reduction processing.

The above screen information reduction method has been described under the assumption that the communication quality 154 remains unchanged while a certain operation that requires a high-speed reactivity of the screen display to an input operation is being performed. In reality, however, the communication quality check processing unit 46 performs the communication quality check at predetermined intervals, and the communication quality information 154 changes. Therefore, in the case where the communication quality information 154 changes from “4” to “3”, the screen information reduction method changes so that the screen information 165 after reduction processing is output instead of the screen information 164 after reduction processing.

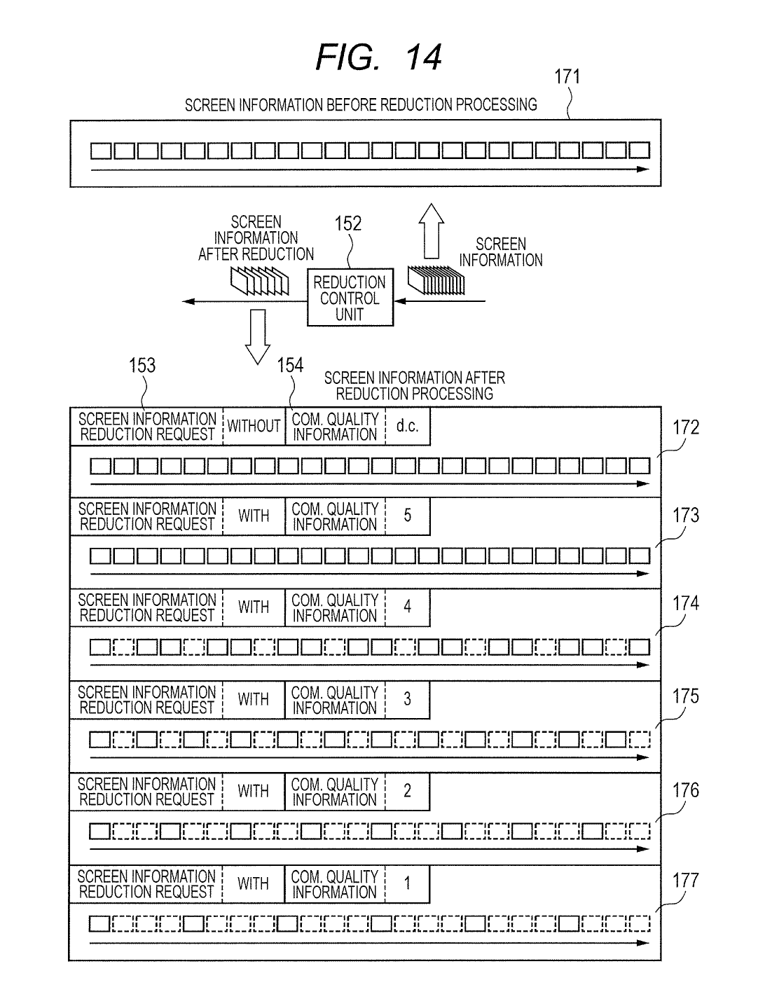

Another screen information reduction method will be described with reference to FIG. 14. FIG. 14 shows that screen information 171 before reduction processing has a series of screen information elements arranged along with the passage of time from left to right. In addition, each of pieces of screen information 172 to 177 after reduction processing also has a series of screen information elements of the screen information on which reduction control is performed by the reduction control unit 152 and which are arranged along with the passage of time from left to right.

The behavior of the reduction control unit 152 in the case where an operation that does not require a high-speed reactivity to an input operation is performed will be described with reference to the screen information 172 after reduction processing. The input operation analysis processing unit 42 does not issue the screen information reduction request 153 to the reduction control unit 152 while an operation that does not require a high-speed reactivity to an input operation such as a character input operation with a keyboard is being performed. Therefore, the reduction control unit 152 outputs the screen information 171 before reduction processing that is not reduced as the screen information 172 after reduction processing regardless of the communication quality information 154 sent from the communication quality check processing unit 46.

Next, the behavior of the reduction control unit 152 in the case where an operation that requires a high-speed reactivity to an input operation is performed will be described with reference to plural pieces of the screen information 173 to 177 after reduction processing. The input operation analysis processing unit 42 issues the screen information reduction request 153 to the reduction control unit 152 while an operation that requires a high-speed reactivity to an input operation such as a scrolling operation with a mouse wheel is being performed. The reduction control unit 152 reduces the amount of data of the screen information 171 before reduction processing so that the resultant amount of data of the screen information can be transmitted without a quantity of delay in the network whose the communication quality is estimated on the basis of the communication quality information 154 from the communication quality check processing unit 46. Afterward, the plural pieces of screen information 173 to 177 after reduction processing obtained in accordance with individual communication qualities are output.

The screen information reduction method described in FIG. 13 is a method in which the screen information elements are thinned out at a certain rate, and the thinned-out screen information elements are not transmitted to the client terminal 1. As a result, if the certain rate at which the screen information elements are thinned out becomes large, the continuity of the reproduced screen is lost, and the screen cannot be smoothly reproduced. Therefore, the method shown in FIG. 14 is a method in which the resolutions of screen information elements are deteriorated instead of screen information elements being thinned out.

In the case where the communication quality information 154 is “5”, since the communication quality is the best, the screen information 171 before reduction processing is output as the screen information 163 after reduction processing after it is not reduced or reduced at a minimum. FIG. 14 shows the screen information 171 before reduction processing whose resolution is not deteriorated at all as the screen information 173 after reduction processing.

In the case where the communication quality information 154 is “4”, since the communication quality is the second-best next to “5”, the resolution of the screen information 171 before reduction processing is deteriorated more than in the case where the communication quality information 154 is “5”, and the resultant screen information is output as the screen information 174 after reduction processing. FIG. 14 shows that the screen information 174 after reduction processing is obtained through reducing the screen information 171 before reduction processing by deteriorating the resolution of one screen information element out of three screen information elements.

In the screen information 174 after reduction processing, screen information elements 178 whose resolutions are not deteriorated are depicted in solid lines, and screen information elements 179 whose resolutions are deteriorated are depicted in dotted lines. The reduction control unit 152 outputs two screen information elements 178 whose resolutions are not deteriorated, and then outputs one screen information element 179 whose resolution is deteriorated so that the amount of data of the screen information element 179 becomes, for example, one fifth, and then repeats the same behavior.

Although the resolution of one screen information element out of three screen information elements is deteriorated in this case, it is conceivable that, in order for the amount of data of the screen information 174 after reduction processing to be less than a predetermined amount of data, the rate of deterioration in the resolution of the one screen information element is adjusted in accordance with the amount of data of the screen information 171 before reduction processing.

In the case where the communication quality information 154 is “3”, since the communication quality is the third-best next to “4”, the resolution of the screen information 171 before reduction processing is deteriorated more than in the case where the communication quality information 154 is “4”, and the resultant screen information is output as the screen information 175 after reduction processing. FIG. 14 shows that the screen information 175 after reduction processing is obtained through reducing the screen information 171 before reduction processing by deteriorating the resolution of one screen information element out of two screen information elements. The reduction control unit 152 outputs one screen information element whose resolution is not deteriorated, and then outputs one screen information element whose resolution is deteriorated so that the amount of data of the latter screen information element becomes one fifth, and then repeats the same behavior.

Although the resolution of one screen information element out of two screen information elements is deteriorated in this case, it is conceivable that, in order for the amount of data of the screen information 175 after reduction processing to be less than a predetermined amount of data, the rate of deterioration in the resolution of the one screen information element is adjusted in accordance with the amount of data of the screen information 171 before reduction processing.

In the case where the communication quality information 154 is “2”, since the communication quality is the fourth-best next to “3”, the resolution of the screen information 171 before reduction processing is deteriorated more than in the case where the communication quality information 154 is “3”, and the resultant screen information is output as the screen information 176 after reduction processing. FIG. 14 shows that the screen information 174 after reduction processing is obtained through reducing the screen information 171 before reduction processing by deteriorating the resolutions of two screen information elements out of three screen information elements. The reduction control unit 152 outputs one screen information element whose resolution is not deteriorated, and then outputs two screen information elements whose resolutions are deteriorated so that the amounts of data of the two screen information elements respectively become one fifth, and then repeats the same behavior.

Although the resolutions of two screen information elements out of three screen information elements are deteriorated in this case, it is conceivable that, in order for the amount of data of the screen information 176 after reduction processing to be less than a predetermined amount of data, the rate of deterioration in the resolutions of the two screen information elements is adjusted in accordance with the amount of data of the screen information 171 before reduction processing.

In the case where the communication quality information 154 is “1”, since the communication quality is the worst, the resolution of the screen information 171 before reduction processing is deteriorated more than in the case where the communication quality information 154 is “2”, and the resultant screen information is output as the screen information 177 after reduction processing. FIG. 14 shows that the screen information 174 after reduction processing is obtained through reducing the screen information 171 before reduction processing by deteriorating the resolutions of three screen information elements out of four screen information elements. The reduction control unit 152 outputs one screen information element whose resolution is not deteriorated, and then outputs three screen information elements whose resolutions are deteriorated so that the amounts of data of the three screen information elements respectively become one fifth, and then repeats the same behavior.

Although the resolutions of three screen information elements out of four screen information elements are deteriorated in this case, it is conceivable that, in order for the amount of data of the screen information 177 after reduction processing to be less than a predetermined amount of data, the rate of deterioration in the resolutions of the three screen information elements is adjusted in accordance with the amount of data of the screen information 171 before reduction processing.

The above screen information reduction method has been described under the assumption that the communication quality 154 remains unchanged while a certain operation that requires a high-speed reactivity of the screen display to an input operation is being performed. In reality, however, the communication quality check processing unit 46 performs the communication quality check at predetermined intervals, and the communication quality information 154 changes. Therefore, in the case where the communication quality information 154 changes from “4” to “3”, the screen information reduction method changes so that the screen information 175 after reduction processing is output instead of the screen information 174 after reduction processing.

The above-described screen information reduction method is a method for reducing screen information in which at least one screen information element whose resolution is not deteriorated and at least one screen information element whose resolution is deteriorated are alternately transmitted to the client terminal, and the reduction amount of the screen information is changed by changing the ratio of the numbers of both screen information elements. Therefore, in the case where screen information is reduced, an image with a deteriorated resolution is displayed at the client terminal 1, hence, even if a large amount of the screen information is reduced, an image with a certain level of continuity can be displayed. In this method, however, since the resolutions of screen information elements are dynamically changed, processing becomes more complex than the screen information reduction method shown in FIG. 13, and there is a possibility that a heavier load is imposed on the server apparatus 3. Therefore, it is conceivable that either the first method shown in FIG. 13 or the second method shown in FIG. 14 is selected in accordance with the specification of a thin client system to be configured.

Alternatively, it is conceivable that an operation type specifying item for specifying one of the two operation types of the immediate response requesting operation, which requests a high-speed reactivity to an operation, is appended to the screen information reduction request 153 output from the input operation analysis processing unit 42 to the reduction control unit 152, and the reduction control unit 152 switches between the above-described two screen information reduction methods in accordance with the operation type specifying item input from the input operation analysis processing unit 42.

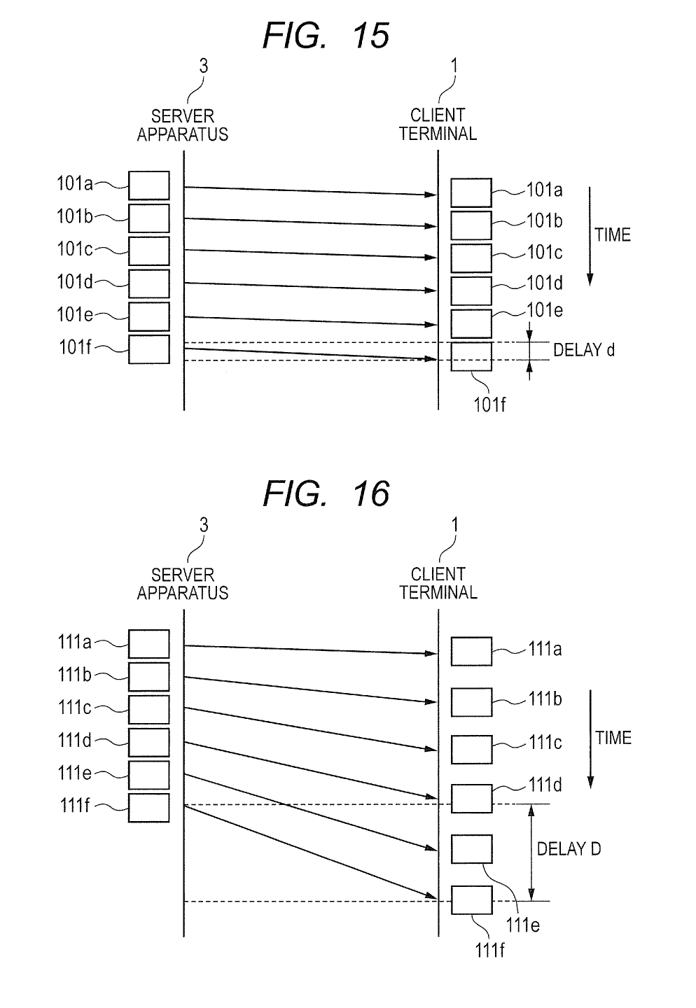

A screen information transmission method in which screen information is from the server apparatus 3 to the client terminal 1 will be described with reference to FIG. 15. In FIG. 15, it will be assumed that the communication quality of the network 2 that connects the server apparatus 3 and the client terminal 1 is good. A screen information element 101a transmitted from the server apparatus 3 is displayed at the client terminal 1 after passing through the network 2. In FIG. 15, the passage of time is depicted in the vertical direction from top to bottom. A screen information element 101b, which is transmitted from the server apparatus 3 after the screen information 101a, is displayed at the client terminal 1 in the same way as the screen information element 101a is displayed. Subsequently, a screen information element 101c, a screen information element 101d, a screen information element 101e, and a screen information element 101f are also displayed at the client terminal 1 in this order in the same way as the screen information element 101a is displayed. In this case, since the communication quality of the network 2 is good, even if the screen information element 101a to the screen information element 101f are continuously transmitted from the server apparatus 3 in this order, there arises no stagnation of the screen information in the network 2, hence a delay d that is a time-lag between the time when screen information is transmitted from the server apparatus 3 and the time when the screen information is displayed at the client terminal 1 does not become large.

In the case where the communication quality of the network 2 that connects the server apparatus 3 and the client terminal 1 is bad and screen information is not reduced, the behavior of the thin client system will be described with reference to FIG. 16. In FIG. 16, a screen information element 111a transmitted from the server apparatus 3 is displayed at the client terminal 1 after passing through the network 2. In FIG. 16, the passage of time is depicted in the vertical direction from top to bottom. A screen information element 111b, which is transmitted from the server apparatus 3 after the screen information element 111a, is displayed at the client terminal 1 in the same way as the screen information element 111a is displayed. Subsequently, a screen information element 111c, a screen information element 111d, a screen information element 111e, and a screen information element 111f are also displayed at the client terminal 1 in this order in the same way as the screen information element 111a is displayed. In this case, since the communication quality of the network 2 is bad, and a bandwidth sufficient to transmit screen information cannot be secured, there arises a delay D in the reception of the screen information at the client terminal 1. As a result, intervals among the times when the screen information elements 111a to 111f are displayed at the client terminal become larger and larger along with the passage of time than intervals among the times when the screen information elements 111b to 111f are transmitted from the server apparatus 3. Therefore, in such a situation, respective time-lags between the displays of the screen information elements 111b to 111f at the client terminal 1 and input operations corresponding to the screen information elements 111b to 111f at the server apparatus 1 become larger along with the passage of time.

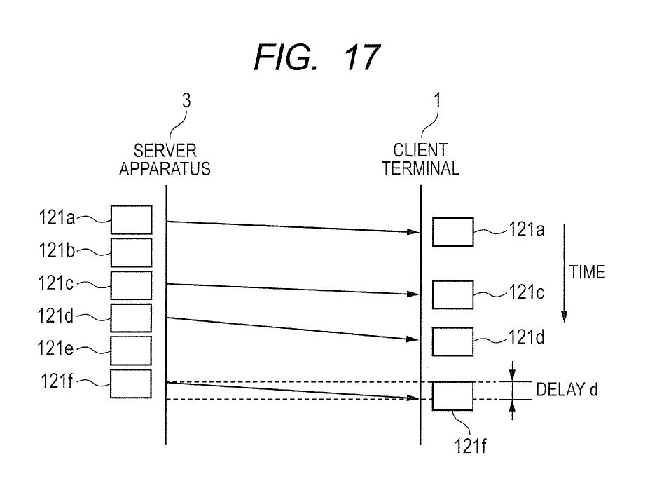

In the case where a high-speed reactivity to an input operation is required, the communication quality of the network 2 that connects the server apparatus 3 and the client terminal 1 is bad, and screen information is reduced, the behavior of the thin client system will be described with reference to FIG. 17. Here, the first method that has been described with reference to FIG. 13 will be adopted as a screen information reduction method for description. In FIG. 17, on receiving a screen information reduction request from the input operation analysis processing unit 42, the screen information generation processing unit 44 of the server apparatus 3 reduces the amount of screen information to be transmitted to the client terminal 1 by thinning out the screen information elements at a constant rate. At this time, the constant rate at which the screen information elements are thinned out is determined on the basis of communication quality information output from the communication quality check processing unit 46. If the communication quality of the network is good, the rate at which the screen information is thinned out is set low, and the rate is set higher as the communication quality becomes worse.

FIG. 17 shows that, after transmitting a screen information element 121a, the server apparatus 3 causes the screen information generation processing unit 44 to delete the next screen information element 121b, hence the next screen information element 121b is not transmitted to the client terminal 1. After transmitting a screen information element 121c, and a screen information element 121d, the server apparatus 3 deletes a screen information element 121e. Afterward, a screen information element 121f is transmitted to the client terminal 1.

Owing to the thinning-out operation of the server apparatus, only screen display 121a, screen display 121c, screen display 121d, and screen display 121f are displayed at the client terminal 1, and screen display 121b and screen display 121e are not displayed. However, since the amount of data transmitted from the server apparatus 3 to the client terminal 1 is reduced, a delay, which occurs when screen information is transmitted from the server apparatus 3 to the client terminal 1, can be reduced.

In the thin client system according to this embodiment of the present invention, the improvement of a processing response to a user operation that requires a high-speed reactivity to the user operation can be achieved. In addition, even in the case where the client terminals and the server apparatus are connected via plural networks with different communication qualities or via a network with a dynamically changing communication quality, a flexible screen display that copes with the communication quality of the entirety of the thin client system can be obtained.

What is claimed is:

1. A thin client system comprising:
a client terminal; and
a server apparatus which is connected with the client via a network;
wherein the client terminal transmits input operation information to the server apparatus via the network;
the server apparatus performs application processing on the basis of the received operation information, generates image information on the basis of the processing result, and transmits the image information to the client terminal via the network;
the client terminal displays the received image information;
the client terminal and the server apparatus are respectively equipped with communication quality check processing units for measuring the communication quality of the network; and
the server apparatus determines an amount of data of the image information to be transmitted to the client terminal on the basis of the communication quality.

2. The thin client system according to claim 1,
wherein the measurement of the communication quality of the network is performed at predetermined intervals; and
the server apparatus determines the amount of data of the image information to be transmitted to the client terminal on the basis of the dynamically changing communication quality.

3. The thin client system according to claim 1, wherein the server apparatus analyzes the operation information and determines the amount of data of the image information to be transmitted to the client terminal on the basis of the analysis result.

4. The thin client system according to claim 2, wherein the server apparatus analyzes the operation information and determines the amount of data of the image information to be transmitted to the client terminal on the basis of the analysis result.

5. A server apparatus that receives operation information from a client terminal, performs application processing, generates image information on the basis of the processing result, and transmits the image information to the client terminal via the network, comprising:
a communication quality check processing unit for measuring the communication quality of the network,
wherein the server determines the amount of data of the image information to be transmitted to the client terminal on the basis of the communication quality.

6. The server apparatus according to claim 5, wherein the server apparatus performs the measurement of the communication quality of the network at predetermined intervals, and determines the amount of data of the image information to be transmitted to the client terminal on the basis of the dynamically changing communication quality.

7. The server apparatus according to claim 5, wherein the server apparatus analyzes the operation information and determines the amount of data of the image information to be transmitted to the client terminal on the basis of the analysis result.

8. The server apparatus according to claim 6, wherein the server apparatus analyzes the operation information and determines the amount of data of the image information to be transmitted to the client terminal on the basis of the analysis result.
